(19) United States
(12) Patent Application Publication
(10) Pub. No.: US 2008/0168226 A1
(43) Pub. Date: Jul. 10, 2008

(54) Correction method for reading data of disk array system

(75) Inventor: Chan-Nan Wang, Kaohsiung County (TW)

Correspondence Address: BACON & THOMAS, PLLC, 625 SLATERS LANE, FOURTH FLOOR, ALEXANDRIA, VA, 22314, US

(73) Assignee: ACCUSYS. INC., HSINCHU (TW)

(21) Appl. No.: 11/649,907

(22) Filed: Jan. 5, 2007

(51) Int. Cl. G06F 12/00

(52) U.S. Cl. 711/114; 711/E12.001

(57) ABSTRACT

A correction method for reading data of a disk array system used for data security and backup of RAID 1 specifies one or more buffers for storing and reading data and an extra buffer. The buffers store data read by the disk array system from a computer system, and the extra buffer temporarily stores the same instruction issued by the disk array controller and the read data of the backup disk from the disk array system. The timeout parameter for the extra buffer to execute the same instructions of reading and returning data to the computer system can be set by users. If the disk array controller executes a read instruction of the computer system and a predetermined timeout parameter expires, the extra buffer will execute the instruction of reading and return the same data to the computer system, so as to reduce the wait time and enhance the reliability.

### BACKGROUND OF THE INVENTION

1. Field of the Invention

The present invention relates to a correction method for reading data of a disk array system, and more particularly to a method applied to a disk array system, such that if the disk array system executes an instruction issued by a computer system to read data, an extra buffer for executing the same instruction will be set up first, and a user can flexibly set a timeout parameter for executing the same instruction from the extra buffer. If a predetermined timeout parameter is exceeded, then the extra buffer will execute the same read instruction and timely return the data to the computer system, so as to reduce the wait time for the computer system to read data and improve the reliability and efficiency of executing the application programs.

2. Description of the Related Art

Disk is one of the present popular information storage devices that features an advantage of a large capacity and becomes a common necessary storage device. In recent years, the capacity, access speed and reliability of the disk are improved greatly, but the improvements still cannot meet user requirements for the security of important document files, and thus finding a way to protect important document files becomes a bottleneck of the development of computer systems.

To meet the requirements for protecting important document files, various different measures were proposed. For instance, a redundant array of inexpensive disks (RAID) proposed by a group of researchers of U. C. Berkeley in 1987 is one of the proposals.

The foregoing disk arrays for storing and protecting important document files are divided into different levels including RAID 1, RAID 2, RAID 3, RAID 4 and RAID 5 according to different management methods.

RAID 1 is the most popular management method among all levels of RAID, and RAID 1 writes the same data into each disk in the array to provide an error tolerance capability, and such method leaves a mirrored copy on each disk. Due to the simplicity and the relatively high data applicability, mirror storage has been welcome by users all the time. However, RAID 1 has its drawbacks on reading data. Referring to FIG. 1, the structure comprises a computer system 10 electrically connected to a disk array system 20, and the disk array system 20 includes a disk array controller 30 and a disk area 40. The disk array controller 30 includes a microprocessor (not shown in the figure) and a random access memory (RAM) 31, and the random access memory (RAM) 31 defines a plurality of buffers 311 for storing data read from a main disk 41 or a backup disk 42 of a disk area 40 (wherein the main disk and backup disk are defined relatively, and the disk reading a data is defined as a main disk, and the other disk is defined as a backup disk). If the computer system 10 needs to read a data from the main disk 41, the computer system 10 will issue an instruction to the disk array controller 30, and then the disk array controller 30 will process according to the instruction. Referring to FIG. 2 for reading data as described here, it is assumed that the required data are continuous, and the size of data read each time is equal to one buffer, and the method of reading data is described as follows (which refers to continuously reading data by a computer system, and the mentioned first and second instructions or first and second records of data or first and second buffers refer the sequence of the execution:

Step 1: If the computer system 10 has issued a first instruction to the disk array controller 30 for reading a first record of data of a first buffer 311, the first record of data of the main disk 41 will be processed.

Step 2: This step checks whether or not the record of data exists in the first buffer 311 specified by the disk array controller 30; if yes, then go to Step 3, or else go to Step 4.

Step 3: This step returns the read data to the computer system 10.

Step 4: This step checks whether or not the main disk 41 is ready; if yes, then go to Step 5, or else go to Step 10.

Step 5: The first buffer executes a read instruction for reading data in the main disk 41, and meanwhile the second buffer executes a read instruction for reading a second record of data in the backup disk 42.

Step 6: This step checks whether or not the first buffer 311 has read the data of the main disk 41; if yes, then go to step 3 to return the data to the computer system 10, or else go to Step 7.

Step 7: This step checks whether or not the reading of the instruction fails or exceeds a predetermined reading time; if yes, then go to Step 8, or else go to Step 6.

Step 8: The first buffer 311 issues a first instruction to the backup disk 42 to execute reading the first record of data again.

Step 9: This step checks whether or not the first record of data returned to the backup disk 42 is received; if yes, then go to Step 3 to return the data to the computer system 10, or else wait for the completion of reading the instruction.

Step 10: Check whether or not the backup disk 42 is ready again; if yes, then go to Step 11.

Step 11: The first buffer 311 executes the read instruction for reading a first record of data of the backup disk 42, and meanwhile the second buffer 311 issues an instruction to the main disk 41 to read a second record of data, and go to Step 6.

However, such method has its drawbacks, since the maximum response time for the main system 10 to read data is the checkout time for waiting for data to be returned to the main disk 41 plus the time (which is approximately 6 sec.) for executing the same instruction for the backup disk 42, and thus such response time is not acceptable to software requiring a timely response, or even causes errors to the execution of software.

### SUMMARY OF THE INVENTION

In view of the shortcomings of prior art, the inventor of the present invention based on years of experience in the related industry to conduct extensive researches and experiments, and finally invented a correction method for reading data of a disk array system.

Therefore, it is a primary objective of the present invention to provide a correction method for reading data of a disk array system, and the method is applied for data security and backup in a RAID of the disk array system, one or more buffer is specified in a random access memory (RAM) of the disk array control system for storing read data and an extra buffer is added. The buffer is provided for temporarily storing the data read from a disk in the disk array system of the computer system, and the extra buffer is provided for processing the same instruction issued by the disk array controller and reading data from the backup disk of the disk array system.

Another objective of the present invention is to provide a correction method for reading data of a disk array system, wherein extra buffer will automatically duplicate the instruction for repeating the execution of reading the same data into a disk area and the data will be returned to the computer system to reduce the time for waiting for the reading of data in the computer system and enhance the reliability and performance of application programs, if the disk array controller executes an instruction issued by the computer system for reading data in the main disk, and a predetermined timeout parameter is exceeded.

A further objective of the present invention is to allow a user to set a timeout parameter flexibly according to the tolerance of a response time of reading data by an operating system of a computer system response time, and the parameter can be set from 0 to ∝, such that if the timeout parameter is set to 0, the disk array controller will simultaneously issue a read instruction for reading data from a buffer and an extra buffer; and if the timeout parameter is set to ∝, the disk array controller will control the data reading method the same as the prior art and will not repeat issuing the read instruction for reading data from the extra buffer.

In the correction method for reading data of a disk array system in accordance with the present invention, the timeout parameter is sometimes set to be larger than several times of the data read time, and thus the disk array system can read new data from the backup disk during this time period, and data will not be read from the extra buffer during the normal allowed time. The extra buffer will be used for reading the backup disk, only if it is a critical timeout parameter and the data has not been responded yet, so as to achieve a better performance.

To make it easier for our examiner to understand the present invention, the following embodiment accompanied with the related drawings are described in details.

### BRIEF DESCRIPTION OF THE DRAWINGS

FIG. 1 is a schematic view of a structure of a prior art; and

FIG. 2 is a flow chart of reading data according to a prior art;

FIG. 3 is a schematic view of a structure of the present invention; and

FIG. 4 is a flow chart of reading data according to the present invention.

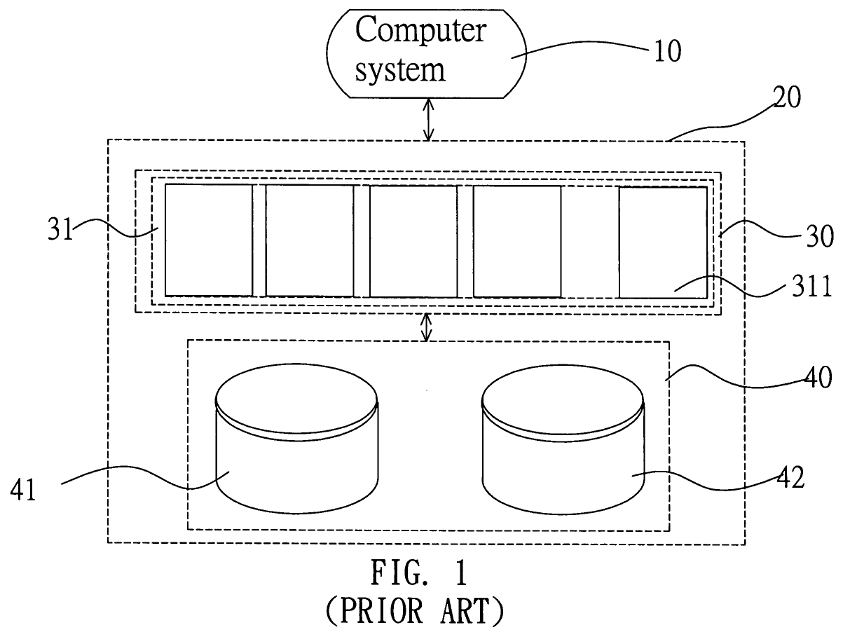

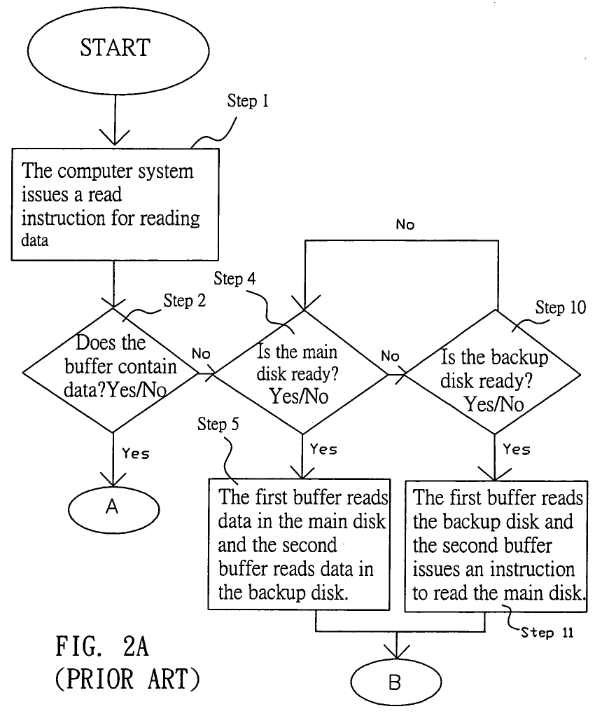

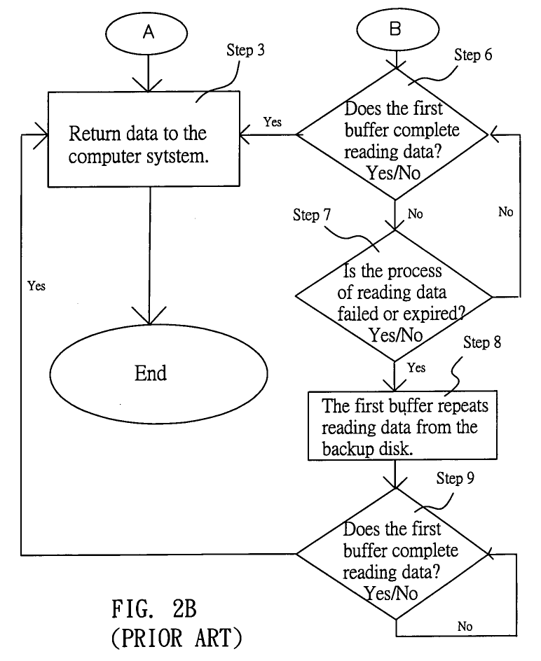

### DETAILED DESCRIPTION OF THE PREFERRED EMBODIMENTS

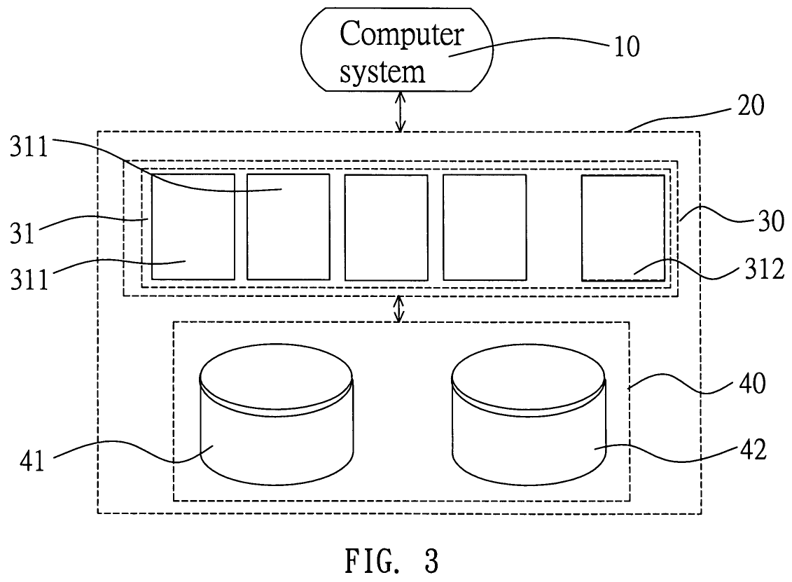

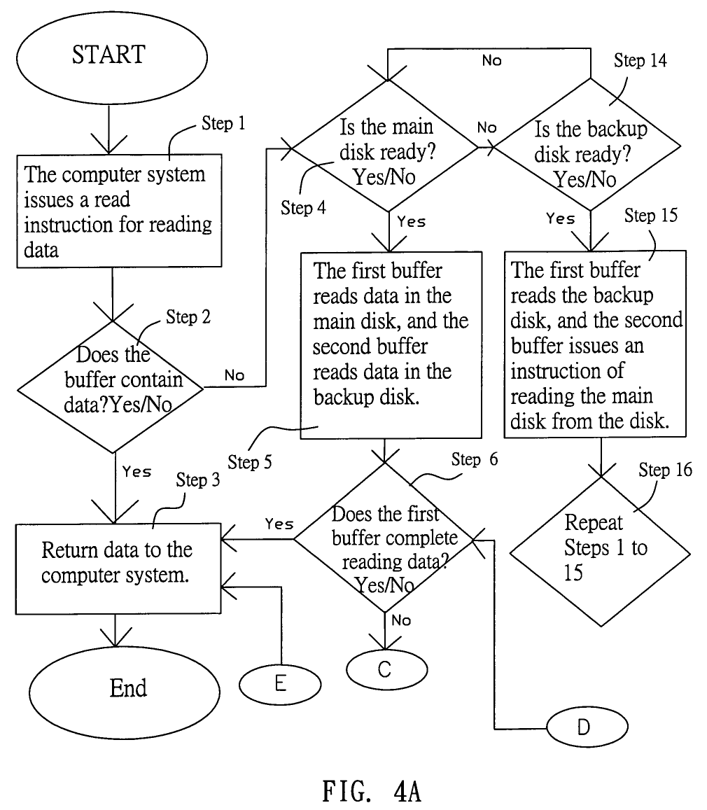

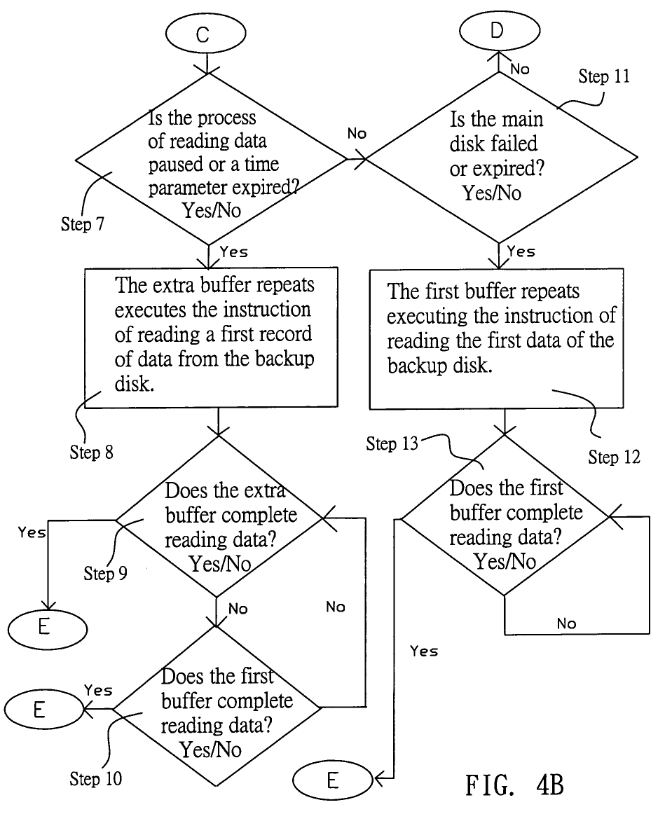

Referring to FIG. 3, the structure comprises a computer system 10, and the computer system 10 is electrically connected to a disk array system 20, and the disk array system 20 has a disk array controller 30 and a disk area 40, and the disk array controller 30 includes a microprocessor (not shown in the figure) and a random access memory (RAM) 31, and the random access memory (RAM) 31 defines a plurality of buffers 311 and an extra buffer 312. The buffer 311 and extra buffer 312 temporarily stores data read by a main disk 41 or a backup disk 42. If the computer system 10 needs to read data in the main disk 41, the computer system 10 will issue an instruction to the disk array controller 30, and the disk array controller 30 will execute according to the instruction Referring to FIG. 4, the method of the present invention reads data as follows:

Step 1: If the computer system 10 has issued a first instruction to a first buffer 311 in the disk array controller 30 for reading a first record of data, the first record of data in the main disk 41 will be read.

Step 2: This step checks whether or not a first buffer 311 specified by the disk array controller 30 has read the first record of data from the main disk 41; if yes, then go to Step 3, or else go to Step 4.

Step 3: This step returns the data read from the main disk 41 to the computer system 10.

Step 4: This step checks whether or not the main disk 41 is ready; if yes, then go to Step 5, or else go to Step 14.

Step 5: If the first buffer 311 executes reading data in the main disk 41, the second buffer 311 also will execute reading a second record of data in the backup disk 42.

Step 6: This step checks whether or not the first buffer 311 has read the data of the main disk 41; if yes, then go to Step 3 to return the data to the computer system 10, or else go to Step 7.

Step 7: This step checks whether or not a predetermined timeout parameter is expired; if yes, than go to Step 8, or else go to Step 11.

Step 8: The extra buffer 312 repeats executing the instruction of reading the first record of data from the backup disk 42.

Step 9: This steps checks whether or not the extra buffer 312 has received the data returned from the backup disk area 42; if yes, then go to Step 3 to return the data to the computer system 10, or else go to Step 10.

Step 10: This step checks whether or not the first buffer 311 has received the data returned from the main disk 41; if no, then go to Step 9, or else go to Step 3 to return the date to the computer system 10.

Step 11: This step checks whether or not the reading of the main disk 41 fails or expires the data return time; if yes, then go to Step 12, or else go to Step 6 and check whether or not the first buffer 311 has read the data of the main disk 41.

Step 12: The first buffer 311 repeats the execution of the instruction for reading the first record of data from the backup disk 42.

Step 13: This step checks whether or not the first buffer 311 has received the first record of data of the backup disk 42; if yes, then go to Step 3 to return the data to the computer system 10, or else wait for completing the read instruction.

Step 14: If the main disk 41 is abnormal, then this step will check whether or not the backup disk 42 is ready; if no, then the this step will check whether or not the main disk 41 is ready again; if yes, then go to Step 15.

Step 15: The first buffer 311 executes the instruction of reading a first record of data from the backup disk 42, and meanwhile the second buffer 311 reads a second record of data of the main disk 41.

Step 16: This step repeats the foregoing Steps 1 to 15.

The extra buffer 312 of the random access memory 31 is provided for users to set a timeout parameter for the extra buffer 312 to execute returning the read data to the computer system. If the timeout parameter is set to 0, the disk array controller 30 will issue a read instruction simultaneously to the buffer 311 and the extra buffer 312. If the timeout parameter is set to ∝ (infinite) and this embodiment is set to the time larger than 12 seconds, the disk array controller 30 will control the method of reading data the same as the prior art and will not repeat issuing the read instruction for reading data from the extra buffer. Therefore, users can modify the data reading method according to actual practical needs and requirements of the application programs, to reduce the wait time for the computer system to read data and improve the reliability and efficiency of executing the application programs.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A correction method for reading data of a disk array system, which is applied mainly for data security and backup for RAID 1 of said disk array system of a computer system, and said disk array system includes a disk array controller, and said disk array controller includes a random access memory and a plurality of disks, and said disks define a main disk and a backup disk, and said method comprising:
defining said random access memory of said disk array controller into a plurality of buffer and an extra buffer, and said buffer receives an instruction of said disk array controller and temporarily stores the data read from said disks;
setting a timeout parameter in said disk array controller for said extra buffer to repeat executing said read instruction for reading data in said backup disk;
if said computer system issues a read instruction through said disk array controller, said buffer will read disk data according to an executed program and return said data to said computer system; if a response time for said buffer to return read data exceeds a predetermined timeout parameter, then said disk array controller will issue said same read instruction from said extra buffer to read data from said backup disk.

2. The correction method for reading data of a disk array system of claim 1, wherein said disk array controller will issue an instruction simultaneously to said buffer and said extra buffer of reading data from said main disk and said backup disk, if said timeout parameter is set to zero.

3. The correction method for reading data of a disk array system of claim 1, wherein said disk array controller will not issue a read instruction for reading a disk data through said extra buffer, if said timeout parameter is set to infinite.

4. The correction method for reading data of a disk array system of claim 1, wherein said disk array controller is a standalone controller installed outside said computer system.

5. The correction method for reading data of a disk array system of claim 1, wherein said disk array controller is an interface card inserted into said computer system.
